(19) United States
(12) Patent Application Publication
(10) Pub. No.: US 2015/0050522 A1
(43) Pub. Date: Feb. 19, 2015

(54) LITHIUM-RICH LAYERED OXIDE CATHODES AND RECHARGEABLE BATTERIES CONTAINING LITHIUM-RICH LAYERED OXIDES

(71) Applicants: Arumugam Manthiram, Austin, TX (US); Eun Sung Lee, Austin, TX (US)

(72) Inventors: Arumugam Manthiram, Austin, TX (US); Eun Sung Lee, Austin, TX (US)

(21) Appl. No.: 13/967,129

(22) Filed: Aug. 14, 2013

(51) Int. Cl. H01M 4/131

(52) U.S. Cl. CPC H01M 4/131; H01M 2004/028
USPC 429/7; 429/223

(57) ABSTRACT

The present disclosure relates to an electrochemically active lithium-rich layered oxide having the general formula Li_{[(1.33-0.67x-y)}Mn_{(0.67-0.5z-0.33x)}Ni_{(x-0.5z+2y)}M_{(z-y)}O₂, wherein M is cobalt (Co), chromium (Cr), or any combinations thereof, wherein, with respect to the amount of Li, 1<(1.33−0.67x−y)<1.2, wherein, with respect to the amount of Mn, 0.5<(0.67−0.5z−0.33x)<0.6, wherein, with respect to the amount of Ni, 0.2<(x−0.5z+2y)<0.5, and wherein, with respect to the amount of M, 0<(z−y)<0.13. The present disclosure further relates to cathodes and rechargeable batteries containing such a lithium-rich layered oxide.

### STATEMENT OF GOVERNMENT INTEREST

The present invention was developed using funds from the Department of Energy under Grant No. RFP-DY-2011-04. The United States Government has rights to this invention.

### TECHNICAL FIELD

The present disclosure relates to lithium-rich layered oxides. The present disclosure also relates to methods of forming such oxides as well as cathodes and rechargeable batteries containing lithium-rich layered oxides and methods of making such cathodes and rechargeable batteries.

### BACKGROUND

Lithium ion batteries are a type of rechargeable battery commonly in use today. Like all batteries, lithium ion batteries chemically store energy and can convert it to electrical energy in the form of an electric current when the battery is discharged. Rechargeable batteries also have the capacity to convert electrical energy to a stored chemical form when they are charged. The process of a single charge combined with a single discharge of a rechargeable battery is referred to as a battery cycle. Although the process of converting energy back and forth between its electrical and chemical forms is not entirely efficient, batteries remain one of the best ways of storing energy to power electronics and electric motors when they cannot be connected to a direct electrical energy source, such as a wall plug or generator.

In lithium ion batteries, lithium ions (Li⁺) move back and forth between the cathode and the anode (both referred to as electrodes) through a lithium-ion-conducting electrolyte as the battery is discharged and charged. At the same time, electrons (e⁻) move between the cathode and anode via electrically conductive portions of the battery and an external device, such as a charger or a car or electronics being powered by the battery.

In most lithium ion batteries, the lithium ions and electrons actually enter and leave the electrodes as the battery is charged and discharged. The electrodes contain electrochemically active materials that allow this movement of lithium ions and electrons. Although a variety of electrochemically active electrode materials are known today, the most commonly used cathode materials contain oxides or other oxygen-based compounds. In particular, lithium cobalt oxide (LiCoO₂) and variations thereof are the electrochemically active cathode material in most lithium ion batteries in use today. Lithium cobalt oxide crystal contains layers of cobalt oxide. Lithium ions reside between these layers or, when the lithium ions leave the lithium cobalt oxide, the layers simply remain in place with fewer lithium ions between them (FIG. 1.) Because the lithium ions can enter and leave the cobalt oxide portion of the crystal without changing the basic crystal structure, lithium cobalt oxide may also be referred to as a solid solution in which the lithium ions are the solute and the cobalt oxide is the solvent.

Although lithium cobalt oxide has proven to be very versatile and useful, there are drawbacks to this material. Cobalt is very expensive, largely due to the increase in demand for cobalt-containing lithium ion batteries over the past twenty years. Cobalt can also be toxic to humans and animals, who absorb it the same way the nutrient, Iron, is absorbed from food. The cost and safety problems with the use of lithium cobalt oxide have encouraged the development of variant materials in which cobalt is substituted with other metals, such as LiNi_{1/3}Mn_{1/3}Co_{1/3}O₂ and LiNi_{0.8}Co_{0.15}Al_{0.05}O₂, or alternative materials in which cobalt is not necessary at all, such as LiMn₂O₄. However, most of these materials have charge storage capacities less than 200 mAh/g.

Various materials have been developed to attempt to improve upon lithium cobalt oxide cathodes. One type of material which does exhibit improvements in capacity as compared to lithium cobalt oxide is referred to as lithium-rich layered oxide. Lithium-rich layered oxides have a structure similar to that of lithium cobalt oxide in that they have metal oxide and lithium ion layers, but they contain more lithium ions in total than lithium cobalt oxide and these extra lithium ions are found in the metal layers. In particular, lithium-rich layered oxides typically have the general formula LiMO₂, where M is a combination of Li, Mn, Ni, and Co.

During battery cycling, lithium ions move in and out of the lithium-rich layered oxide material. Batteries with lithium-rich layered oxides have more capacity and deliver more electrical energy.

Lithium-rich layered oxides are not commonly used in commercial rechargeable batteries, however, because they exhibit a substantial and irreversible decrease in capacity after the first charge and because the voltage they can supply decreases over time (a phenomena called voltage decay) as they are subjected to repeated charge/discharge cycling.

Voltage is one measure of how a battery delivers its stored energy as electrical energy and lower voltages often lead to disadvantages, such as the inability to adequately provide enough electrical energy and power to certain devices, such as electric vehicles. Voltage decay leads to another problem, inaccuracy in estimating the state of charge of the battery (whether it is fully charged, fully discharged, or somewhere in between). Knowing the state of charge is important in preventing a battery from becoming overcharged, which compromises safety, and in preventing the battery from running out of energy too soon because it is undercharged. In an electric car, for example, overcharging may cause a fire and undercharging may leave a driver stranded when the car cannot travel as far as expected.

The reasons for these problems with lithium-rich layered oxides are poorly understood, rendering it difficult to improve lithium-rich layered oxides to the point where they are feasible for use in batteries. Accordingly, a better understanding of the causes of voltage decay is needed.

### SUMMARY

The present disclosure relates to an electrochemically active lithium-rich layered oxide having the general formula Li_{(1.33-0.67x-y)}Mn_{(0.67-0.5z-0.33x)}Ni_{(x-0.5z+2y)}M_{(z-y)}O₂, wherein M is cobalt (Co), chromium (Cr), or any combination thereof, wherein, with respect to the amount of Li, 1<(1.33−0.67x−y)<1.2, wherein, with respect to the amount of Mn, 0.5<(0.67−0.5z−0.33x)<0.6, wherein, with respect to the amount of Ni, 0.2<(x−0.5z+2y)<0.5, and wherein, with respect to the amount of M, 0<(z−y)<0.13.

The present disclosure further relates to cathodes and rechargeable batteries containing such a lithium-rich layered oxide.

### BRIEF DESCRIPTION OF THE DRAWINGS

A more complete understanding of certain embodiments of the present disclosure may be acquired by referring to the following description taken in conjunction with the accompanying drawings.

FIG. 1 presents a side view of a lithium cobalt oxide crystal according to the prior art.

FIG. 2A presents a charge-discharge profile data for coin cells containing a lithium-rich layered oxide with the general formula Li_{1.2}Mn_{0.6}Ni_{0.2}O₂ at the indicated number of cycles.

FIG. 2B presents a charge-discharge profile data for coin cells containing a lithium-rich layered oxide with the general formula Li_{1.2}Mn_{0.54}Ni_{0.13}Co_{0.13}O₂.

FIG. 2C presents a charge-discharge profile data for coin cells containing a lithium-rich layered oxide with the general formula Li_{1.2-x}Mn_{0.54}Ni_{0.13+2x}Co_{0.13-x}O₂ for the indicated values of x=0.05.

FIG. 2D presents a dQ/dV profile for coin cells containing a lithium-rich layered oxide with the general formula Li_{1.2}Mn_{0.6}Ni_{0.2}O₂ at the indicated number of cycles.

FIG. 2E presents a dQ/dV profile for coin cells containing a lithium-rich layered oxide with the general formula Li_{1.2}Mn_{0.54}Ni_{0.13}Co_{0.13}O₂.

FIG. 2F presents a dQ/dV profile for coin cells containing a lithium-rich layered oxide with the general formula Li_{1.2-x}Mn_{0.54}Ni_{0.13+2x}Co_{0.13-x}O₂ for the indicated values of x=0.05.

FIG. 3 presents a cross-section side view of a cathode according to an embodiment of the present disclosure.

FIG. 4 presents a cross-section side view of a rechargeable battery according to an embodiment of the present disclosure.

FIG. 5 presents charge-discharge profile data for coin cells containing a lithium-rich layered oxide with the general formula Li_{1.2-x}Mn_{0.54}Ni_{0.13+2x}Co_{0.13-x}O₂ for x=0 (prior art) and the indicated values of x. Data for the first cycle is presented in FIG. 5A. Data for the 50th cycle is presented in FIG. 5B. Data for the 90th cycle is presented in FIG. 5C.

FIG. 6 presents dQ/dV profiles for coin cells containing a lithium-rich layered oxide with the general formula Li_{1.2-x}Mn_{0.54}Ni_{0.13+2x}Co_{0.13-x}O₂ for x=0 (prior art) and the indicated values of x. Data for the first cycle is presented in FIG. 6A. Data for the 50th cycle is presented in FIG. 6B. Data for the 90th cycle is presented in FIG. 6C.

FIG. 7 presents cyclability data in terms of discharge capacity (FIG. 7A) and discharge energy (FIG. 7B) for coin cells containing a lithium-rich layered oxide with the general formula Li_{1.2-x}Mn_{0.54}Ni_{0.13+2x}Co_{0.13-x}O₂ for x=0 (prior art) and the indicated values of x.

FIG. 8 presents cyclability data at 3 V in terms of discharge capacity (FIG. 8A) and discharge energy (FIG. 8B) for coin cells containing a lithium-rich layered oxide with the general formula Li_{1.2}Mn_{0.54}Ni_{0.13}Co_{0.13}O₂, a prior art oxide, or a lithium-rich layered oxide with the general formula Li_{1.15}Mn_{0.54}Ni_{0.23}Co_{0.08}O₂, an oxide according to the present disclosure.

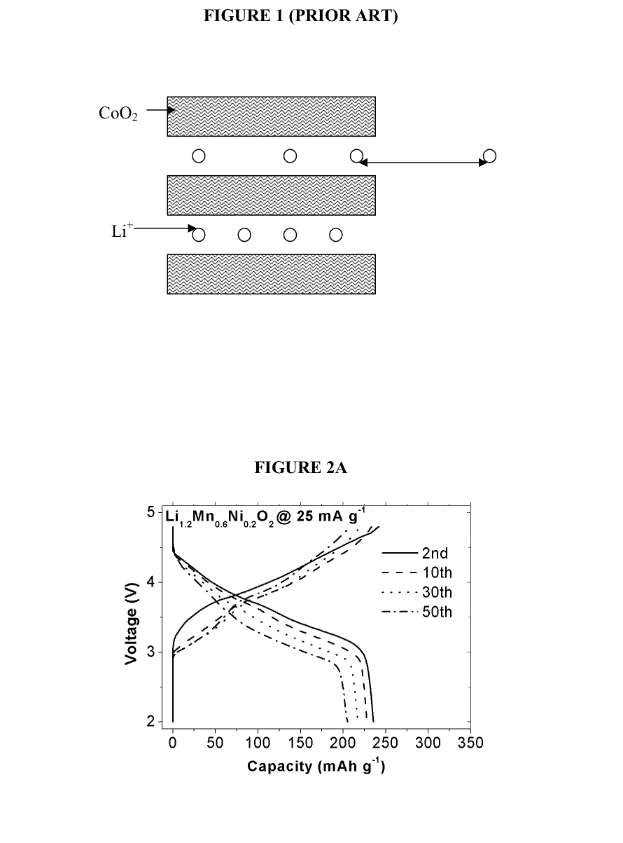

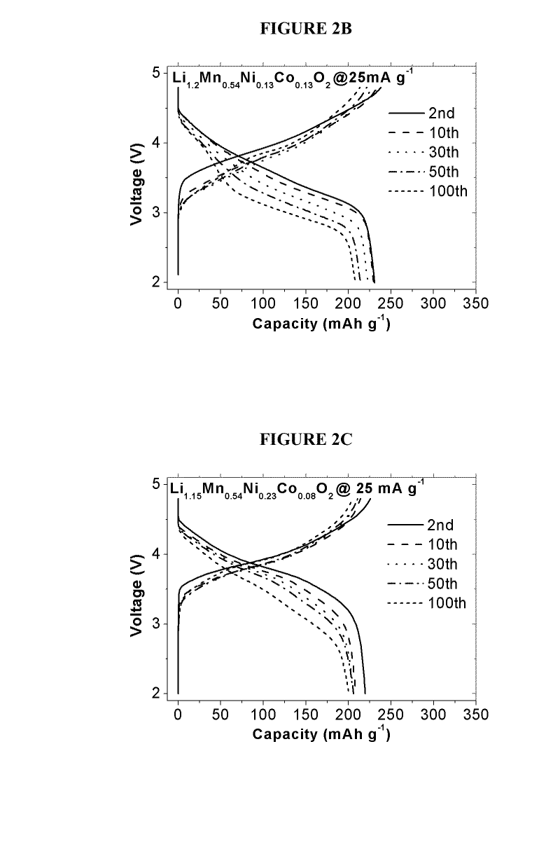

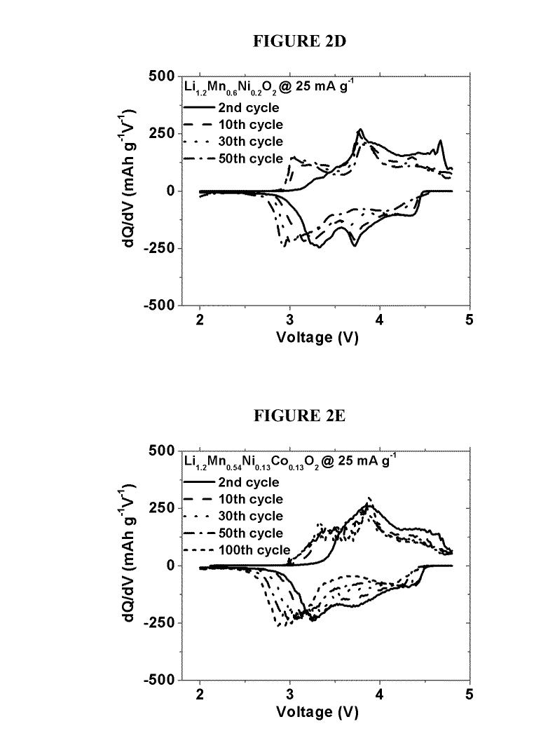

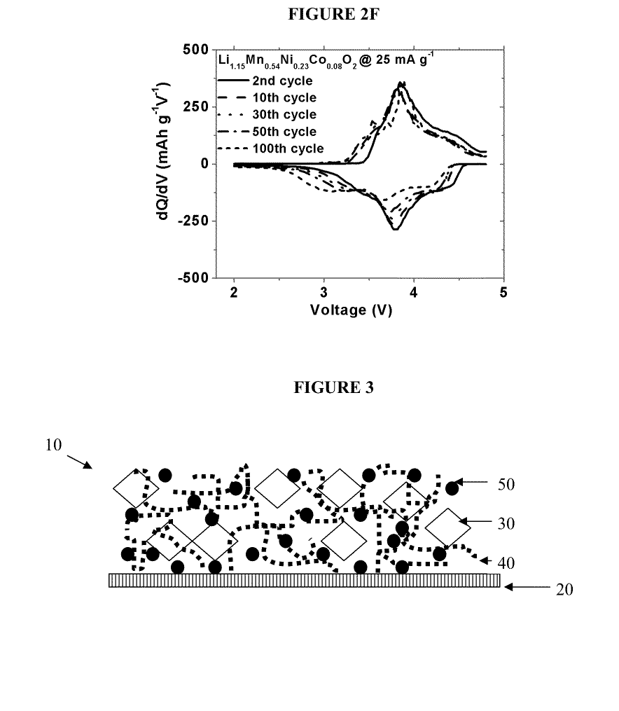

### DETAILED DESCRIPTION

The present disclosure relates to lithium-rich layered oxides. These oxides may contain manganese (Mn), nickel (Ni), and cobalt (Co) and, optionally, chromium (Cr). The present disclosure also relates to methods of forming such oxides as well as cathodes and rechargeable batteries containing such lithium-rich layered oxides and methods of making such cathodes and rechargeable batteries.

### Lithium-Rich Layered Oxides

Lithium-rich layered oxides of the present disclosure may have the general formula Li_{(1.33-0.67x-y)}Mn_{(0.67-0.5z-0.33x)}Ni_{(x-0.5z+2y)}M_{(z-y)}O₂. M is cobalt (Co), chromium (Cr), or any combinations thereof. With respect to the amount of Li, 1<(1.33−0.67x−y)<1.2. With respect to the amount of Mn, 0.5<(0.67−0.5z−0.33x)<0.6. With respect to the amount of Ni, 0.2<(x−0.5z+2y)<0.5. With respect to the amount of M, 0<(z−y)<0.13.

In a specific embodiment, prior to the first charge of a lithium-rich layered oxide in a rechargeable battery, Mn may be in the form of Mn⁴⁺, Ni may be in the form of Ni²⁺, Co may be in the form of Co³⁺, and Cr may be in the form of Cr³⁺. When the lithium-rich layered oxide is in a charged rechargeable battery, Ni may be in the form of Ni⁴⁺, Co may be in the form of Co^{-3.6+}, and Cr may be in the form of Cr⁶⁺.

In a more specific embodiment, the disclosure relates to lithium-rich layered oxides having the general formula Li_{1.2-x}Mn_{0.54}Ni_{0.13+2x}Co_{0.13-x}O₂, where 0<x<0.13 or Li_{1.2-x}Mn_{0.54}Ni_{0.13+2x}Cr_{0.13-x}O₂, where 0<x<0.13. In a particular embodiment, the lithium-rich layered oxide may have the general formula Li_{1.15}Mn_{0.54}Ni_{0.23}Co_{0.08}O₂.

The lithium-rich layered oxides of the present disclosure may be present as single crystals or as agglomerates. Crystals or agglomerates of lithium-rich layered oxides may have an average largest dimension of 1000 μm or less and thus be micro-sized. Crystals or agglomerates may have an average largest dimension of 1000 nm or less and thus be nano-sized.

Lithium-rich layered oxides may be formed into composites including other electrochemically active or non-electrochemically active materials. Such composites may include coatings or agglomerators, such as those previously found to be useful when used with lithium-rich layered oxides. For example, the lithium-rich layered oxides of the disclosure may be coated or layered with vanadium oxide as described in Park, Kyu-Sung, et al., Suppression of O₂ evolution from oxide cathode for lithium-ion batteries: VOₓ-impregnated 0.5Li₂MnO₃-0.5LiNi_{0.4}Co_{0.2}Mn_{0.4}O₂ cathode, Chem. Commun., doi: 10.1039/c0cc00281j (2010), incorporated in material part by reference herein. Lithium-rich layered oxides of the disclosure may also be layered with conductive carbon as described in Ryu, Won-Hee, et al., Electrochemical properties of nanosized Li-rich layered oxide as positive electrode materials for Li-Ion batteries, RSC Advances 3: 8527-8534 (2013), incorporated in material part by reference herein. Lithium-rich layered oxides of the disclosure may also be coated with aluminum oxide (Al₂O₃) or aluminum phosphate (AlPO₄) as described in U.S. Pat. No. 7,678,503, incorporated in material part by reference herein. Additionally, lithium-rich layered oxides of the present disclosure may be coated or layered with conductive carbon, conductive polymer, conductive metal, conductive oxide, or any other conductive material able to increase electrical conductivity of lithium-rich layered oxides or otherwise to able to be coated or layered with such materials.

### Cathodes Containing Lithium-Rich Layered Oxides

Cathodes suitable for use in rechargeable batteries may be formed using lithium-rich layered oxides of the present disclosure. In the embodiment shown in FIG. 3, a cathode 10 may include a conductive layer 20, an electrochemically active material 30, optionally, a binder 40, and, optionally, a conductivity enhancer 50.

Conductive layer 20 may include any material able to physically support a cathode and electrically connect it to a battery component or external device. In particular embodiments, conductive layer 20 may include a metal foil or conductive carbon layer. In more specific embodiments, it may include aluminum foil.

Electrochemically active material 30 may be deposited on conductive layer 20 such that it is in electrical contact with the conductive layer and is physically supported by conductive layer 20. Electrochemically active material 30 may be deposited in a mixture with any binder 40 or conductivity enhancer 50.

Electrochemically active material 50 may include one electrochemically active material, which may be a lithium-rich layered oxide of the present disclosure. It may also include more than one electrochemically active material. In such embodiments, in addition to a lithium-rich layered oxide of the present disclosure, the electrochemically active material 50 may further include a different lithium-rich layered oxide of the present disclosure, a different lithium-rich layered oxide not of the present disclosure, or a material that is not a lithium-rich layered oxide, such as lithium metal oxide, an olivine material, or a spinel.

Electrochemically active material 50 may be micro-sized or nano-sized and may include single crystals, agglomerates, and coated or layered lithium-rich layered oxides as described above.

Binder 40 may physically attach electrochemically active material 50 to conductive layer 20. In many embodiments, binder 40 may include a polymer, such as a carbon-based polymer.

Conductivity enhancer 50 may be in the form of polymers or small particles. It may include metals or conductive carbon. For example, it may include carbon polymers or particles of carbon black or even elemental carbon. Conductivity enhancer 50 may facilitate the movement of electrons between electrochemically active material 50 and conductive layer 20. Conductivity enhancer 50 may be chosen or used in such a manner so as to not substantially impede the movement of lithium ions.

### Rechargeable Batteries Containing Lithium-Rich Layered Oxides

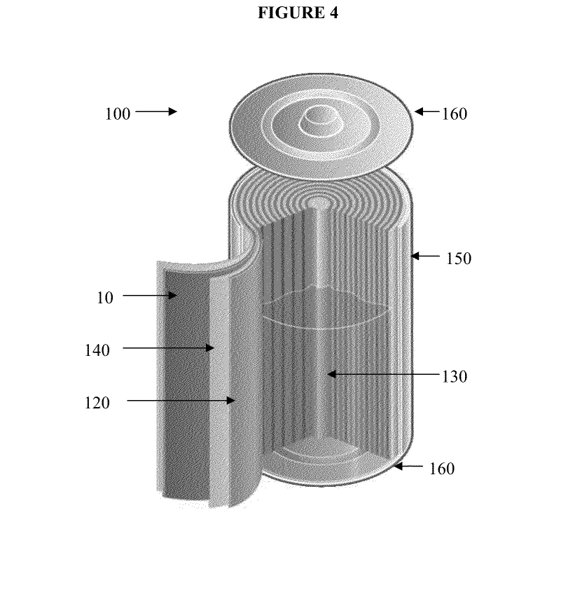

A rechargeable battery with a jelly-roll configuration containing a lithium-rich layered oxide according to the disclosure is shown in FIG. 4. Rechargeable battery 100 contains cathode 10, anode 120, electrolyte 130, electrically insulating separator 140, optionally, case 150, and, optionally, contacts 160. Rechargeable battery 100 may at times be electrically connected to device 170, which may be a charger or a device powered by the battery. Although only one cathode and one anode are described herein, a single battery may contain multiple cathodes and anodes if desired. Similarly, although only one electrolyte is described herein, a single battery may contain more than one electrolyte, particularly if the electrolytes have different physical states.

Cathode 10 may include any cathode as described herein. Anode 120 may include any material known to be suitable for use in a lithium ion battery. Anode 120 may include a material that operates at a voltage of less than 2.0 V vs. lithium metal (Li⁰). The anode may also be selected such that, when combined with cathode 10, the resulting rechargeable battery 100 operates at a voltage of at least 2.0 V. In particular embodiments, anode 120 may include lithium metal, carbon, such as graphite or graphene, modified carbon, such as modified graphite or graphene, or titanate compounds. Anode 120 may include only one or more than one electrochemically active material and may optionally also include a binder or conductivity enhancer. Anode 120 may further include a conductive layer, such as a different metal foil or carbon layer than the one used in conductive layer 20. For instance, anode 120 may include copper foil.

Rechargeable battery 100 may further include electrolyte 130, which may include a liquid, gel, polymer, or solid electrolyte, separator 140, case 150 and contacts 160.

Rechargeable battery 100 may operate at a voltage of at least 2.0 V for at least 100 cycles. In another embodiment, it may operate at a voltage of at least 3.0 V for at least 100 cycles. The voltage decay in a rechargeable battery 100 using a lithium-rich layered oxide of the present disclosure after 10 cycles may be less than the voltage decay experienced in an identically constructed battery using a lithium-rich layered oxide containing less or no cobalt or chromium. The voltage in a rechargeable battery 100 using a lithium-rich layered oxide of the present disclosure may not substantially decrease after 10 cycles. The degree to which voltage decay is lessened may vary depending on the type or configuration of the rechargeable battery and the identity or composition of other cathode and battery components. Due to less voltage decay, a rechargeable battery 100 of the present disclosure may have a higher power density after 10 cycles than an identically constructed battery using a lithium-rich layered oxide containing less or no cobalt or chromium.

Batteries according to the present disclosure do not experience the high irreversible loss of capacity upon first charge seen in prior lithium-rich layered oxide batteries. Rechargeable battery 100 may have a capacity of at least 200 mAh/g for at least 100 cycles.

Rechargeable batteries of the present disclosure may also be adapted for use in a variety of devices, including, but not limited to, cell phones, smart phones, laptop computers, electronic toys and games, power tools, automotive batteries, including car, truck, bus, bicycle, motorcycle, all-terrain vehicle, golf cart, wheelchair, and other personal mobility device batteries, boat and submarine batteries, grid storage systems, emergency or backup electrical systems, and medical devices, such as battery-powered medical carts, defibrillators and emergency medical devices.

Rechargeable batteries of the present disclosure may be arranged in series or in parallel to form larger batteries, which may themselves be arranged in series or in parallel. Such arrangements may result in voltages and capacities higher than those for a single electrochemical cell battery. Rechargeable batteries of the present disclosure may be formed into a variety of battery/cell configurations, including standard cell formats, such as 18650 and 26650 formats, prismatic cells, pouch cells, coin cells, cylindrical cells, button cells, or jelly rolls. Rechargeable batteries of the present disclosure may also be formed into non-standard formats and shapes.

Rechargeable batteries of the present disclosure may be arranged and coupled with other elements suitable for their intended uses. For example, rechargeable batteries of the present disclosure may be coupled with protective materials, which may be as simple as case 150 shown in FIG. 4 or as complicated as weather or impact-resistant housings or fire-retardant materials. Rechargeable batteries of the present disclosure may also be connected with control or monitoring equipment, which may include a computer. This equipment may check battery parameters, such as operating voltage and state of charge. It may also activate safety measures, such as fire suppression measures or emergency shutoff measures, or may provide a warning or status update information to a user. In some uses, such a grid storage and automotive vehicles, rechargeable batteries of the present disclosure may be integrally coupled with complex control and monitoring equipment to form a single functional unit.

In one specific embodiment, the present disclosure includes a rechargeable battery including a lithium-rich layered oxide of the disclosure and a state of charge estimator. The state of charge estimator may be an analog instrument or a digital instrument, such as a computer. The state of charge estimator may be periodically coupled to the rechargeable battery to measure state of charge, or it may be an integral component of the battery. The state of charge estimator may include a readout that indicates whether the battery is fully charged, fully discharged, or somewhere in between. The state of charge estimator may also be coupled to a shutoff mechanism that stops charging when the battery is full and continues to allow charging when it is not. The state of charge estimator may also be connected to an automatic charger, so that charging begins automatically when the battery's charge is below a certain amount. Such systems may be particularly useful in electric vehicles.

### Basis for Improved Performance of Lithium-Rich Layered Oxides of the Present Disclosure

Lithium-rich layered oxides do not retain their layered structure indefinitely. Eventually, metals from the metal oxide layers migrate to the lithium ion layers, causing a gradual change in the crystal structure to that of a spinel. The spinel crystal structure cannot support as high of a voltage as the layered one, and the voltage decrease observed in lithium-rich layered oxides has previously been attributed to this gradual transformation to a spinel-like crystal structure. However, the precise reasons for this transformation were not previously well understood.

Voltage may be measured when a battery is charged and discharged. The voltage changes during the charge and discharge process in a pattern typical of a given electrochemically active material. This pattern is referred to as the charge or voltage profile of the electrochemically active material. Many electrochemically active materials have a substantial voltage plateau, where the voltage is largely unchanged during charge or discharge.

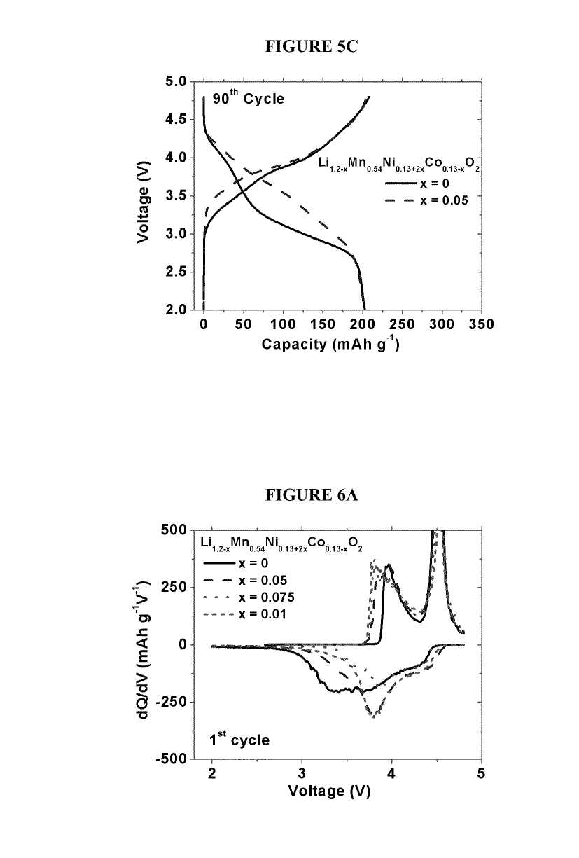

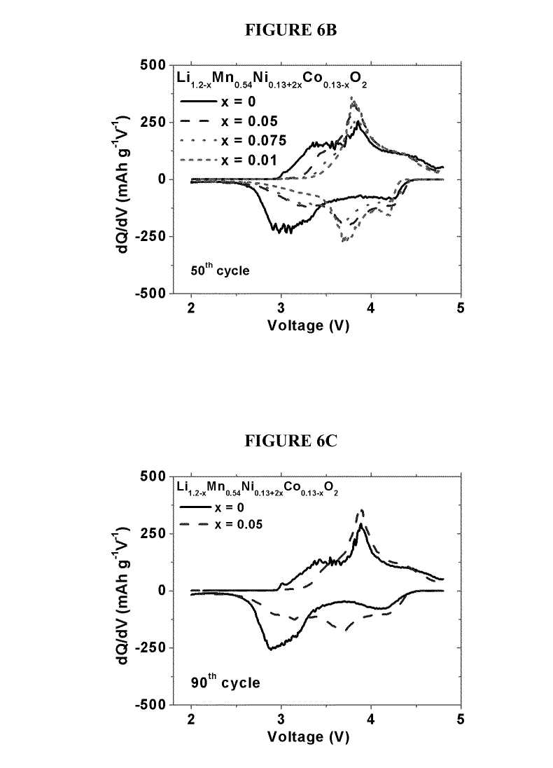

Lithium-rich layered oxides exhibit a voltage plateau (4.5 V) at first charge, which can be seen in FIG. 6. The voltage at which this plateau occurs depends on a variety of factors, including the metal ions in the material. Lithium-rich layered oxides exhibit different charge profiles after the first charge. In particular, during the first charge, the voltage plateau (4.5 V) is very long. This lengthy voltage plateau was previously thought to be related to increased reversible capacity and, thus, to be desirable. Recent experiments have shown that lithium-rich layered oxides with increased amounts of cobalt, causing a longer voltage plateau during the first cycle, also experienced increased voltage decay. This voltage decay appears to result from the increased movement of lithium and transition metal ions from the metal oxide layers into the lithium layers during cycling. In addition, metals may move from the metal oxide layers into the lithium layers when certain dumbbell-shaped structures are temporarily formed in the layered crystal. These dumbbell shapes form more readily when there are more lithium ions in the metal oxide layers.

Accordingly, the presently disclosed lithium-rich layered oxides, which contain less lithium (Li) and less cobalt (Co) than prior lithium-rich layered oxides, exhibit less voltage decay than such prior oxides. By increasing the amount of nickel (Ni) rather than manganese (Mn) in these oxides, the higher capacity of lithium-rich layered oxides may be maintained by a longer sloping region at first charge. Furthermore, the operating voltage may be increased due to the higher nickel (Ni) content. In alternative embodiments, substituting a portion of cobalt (Co) with chromium (Cr) may also decrease the length of the voltage plateau and increase the sloping region during the first cycle and result in less voltage decay while maintaining high capacity.

### EXAMPLES

The present examples are provided to illustrate exemplary embodiments of the invention and comparisons to prior compositions only. They should not be interpreted to encompass the full scope of the invention.

### Example 1

### Material Synthesis and Coin Cell Production

All samples were synthesized by firing the co-precipitated hydroxides of Mn, Co, and Ni with LiOH·H₂O at 900° C. for 12 hours in air with a 3° C./minute heating rate and a 5° C./minute cooling rate. The co-precipitated hydroxides were prepared as described in Lee, E.-S., Huq, A., Chang, H.-Y., and Manthiram, A., “High-voltage, High-energy Layered-Spinel Composite Cathodes with Superior Cycle Life for Lithium-ion Batteries,” Chemistry of Materials 24, 600-612 (2012).

Electrochemical analysis in these examples was carried out using CR2032-type coin cells. The cathodes with the relevant lithium-rich layered oxides were prepared by casting a slurry mixture of 80 wt % lithium-rich layered oxides, 10 wt % super P carbon conductivity enhancer, and 10 wt % polyvinylidine fluoride binder in N-methyl-2-pyrrolidone (NMP) solvent on an aluminum foil conductive layer.

The coin cells were assembled with a lithium metal anode, a Celgard polypropylene separator, and a 1 M LiPF₆ in ethylene carbonate/diethyl carbonate (1:1. v/v) electrolyte.

Similar methods, materials, and relative amounts of materials may be used to form any cathode 10. For example, a slurry of cathode components in a solvent may be prepared and then cast or deposited on a conductive layer. Similar methods and materials may also be used to form any rechargeable battery 100, including those with different anodes, cathodes, electrolytes, and separators.

### Example 2

### Electrochemical Characterization

In order to obtain electrochemical data, coin cells prepared as described in Example 1 were cycled between 2 V and 4.8 V at a rate of 25 mAh/g (C/10) for selected numbers of cycles at room temperature. Voltage decay is enhanced at low current density, so a low current density was used in this example to better elucidate differences in voltage decay.

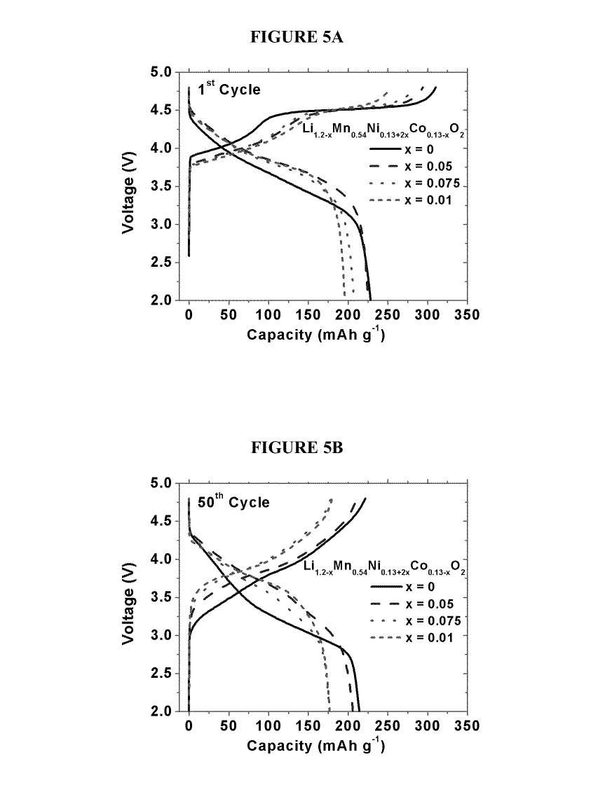

Charge-discharge profiles for coin cells containing a lithium-rich layered oxide with the general formula Li_{1.2-x}Mn_{0.54}Ni_{0.13+2x}Co_{0.13-x}O₂ are shown in FIG. 5 for x=0 (prior art) and the indicated values of x. All coin cells in which x was not 0 exhibited a longer sloping voltage region and shorter voltage plateau region as compared to the prior art (x=0) oxide coin cell.

dQ/dV (change in charge over change in voltage) profiles for coin cells containing a lithium-rich layered oxide with the general formula Li_{1.2-x}Mn_{0.54}Ni_{0.13+2x}Co_{0.13-x}O₂ are shown in FIG. 6 for x=0 (prior art) and the indicated values of x. All coin cells in which x was not 0 exhibited a marked reduction in voltage decay after 50 cycles as compared to the prior art (x=0) oxide coin cell.

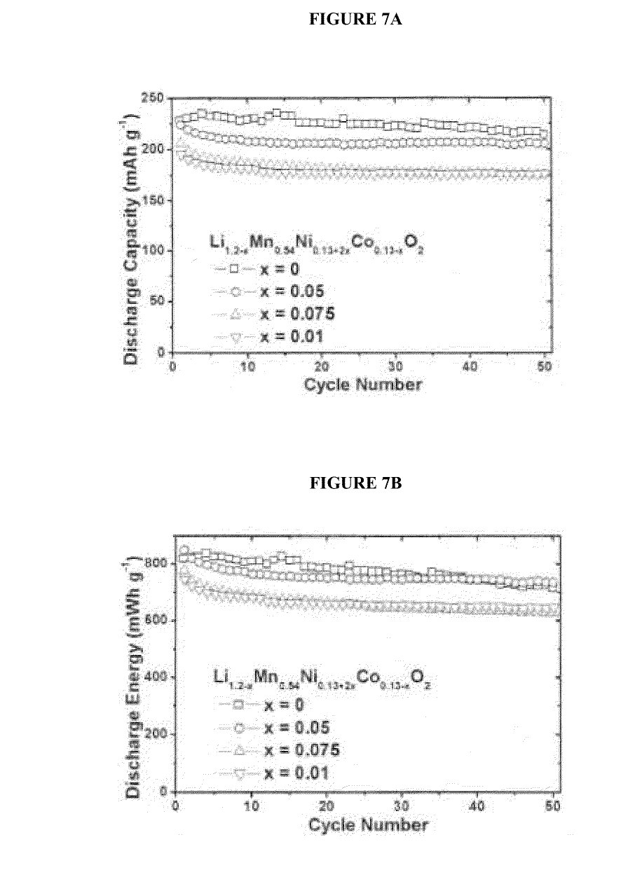

Cyclability in terms of discharge capacity and discharge energy for coin cells containing a lithium-rich layered oxide with the general formula Li_{1.2-x}Mn_{0.54}Ni_{0.13+2x}Co_{0.13-x}O₂ for x=0 (prior art) and the indicated values of x is shown in FIGS. 7A and 7B, respectively. All coin cells in which x was not 0 exhibited improved cyclability as compared to the prior art (x=0) oxide coin cell.

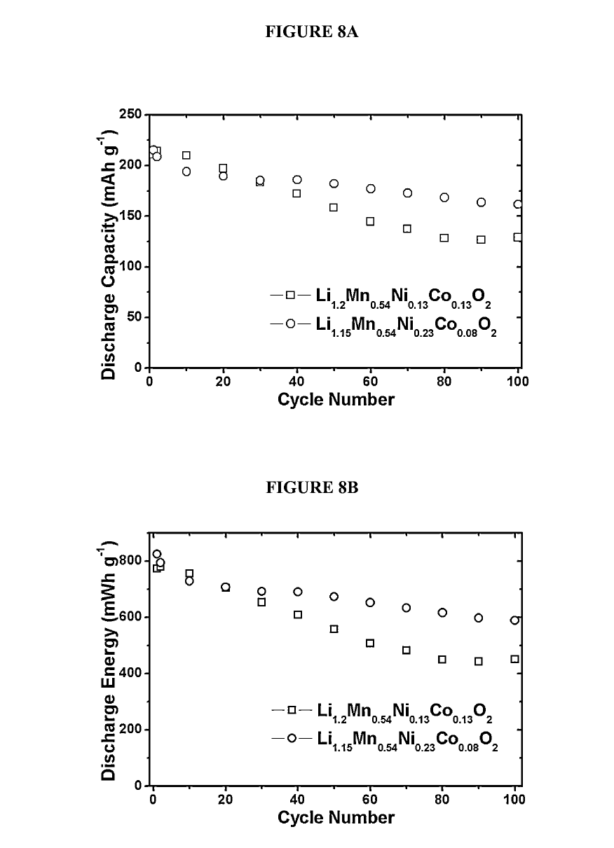

Cyclability in terms of discharge capacity and discharge energy at 3 V for coin cells containing a lithium-rich layered oxide with the general formula Li_{1.2}Mn_{0.54}Ni_{0.13}Co_{0.13}O₂, a prior art oxide, or a lithium-rich layered oxide with the general formula Li_{1.15}Mn_{0.54}Ni_{0.23}Co_{0.08}O₂, an oxide according to the present disclosure, is shown in FIGS. 8A and 8B, respectively. The coin cell with Li_{1.15}Mn_{0.54}Ni_{0.23}Co_{0.08}O₂ exhibited improved cyclability as compared to the one containing the prior art oxide, Li_{1.2}Mn_{0.54}Ni_{0.13}Co_{0.13}O₂.

Although only exemplary embodiments of the invention are specifically described above, it will be appreciated that modifications and variations of these examples are possible without departing from the spirit and intended scope of the invention.

It will be understood throughout the present disclosure that electrochemically active materials included in a cathode are expressed with chemical names and formula denoting the full theoretical amount of lithium they may contain. The actual amount of lithium in these materials will vary during use of a battery and may vary from the theoretical maximum even upon formation, before the first charge/discharge cycle. For example, when a battery is fully charged, the electrochemically active material in the cathode is expected to contain no or only insubstantial amounts of lithium. Also for example, when a material is synthesized, it may contain slightly more or less lithium than indicated by the chemical formula.

Additionally, electrochemically active materials may contain small amounts of contaminants or other elements or compounds that do not significantly affect their function or that are present in only very small amounts. For example, it is difficult to obtain truly pure samples of most oxides, such that small amounts of impurities not indicated in the chemical formula of electrochemically active materials may be present in them. As another example, a different metal, particularly a transition metal, or a metalloid may be added as a dopant.

1. A cathode comprising an electrochemically active lithium-rich layered oxide having the general formula Li_{(1.33-0.67x-y)}Mn_{(0.67-0.5z-0.33x)}Ni_{(x-0.5z+2y)}M_{(z-y)}O₂,
wherein M is cobalt (Co), chromium (Cr), or any combination thereof,
wherein, with respect to the amount of Li, 1<(1.33−0.67x−y)<1.2,
wherein, with respect to the amount of Mn, 0.5<(0.67−0.5z−0.33x)<0.6,
wherein, with respect to the amount of Ni, 0.2<(x−0.5z+2y)<0.5, and
wherein, with respect to the amount of M, 0<(z−y)<0.13.

2. The cathode of claim 1, wherein the lithium-rich layered oxide has the general formula Li_{1.2-x}Mn_{0.54}Ni_{0.13+2x}Co_{0.13-x}O₂, wherein 0<x<0.13.

3. The cathode of claim 1, wherein the lithium-rich layered oxide has the general formula Li_{1.15}Mn_{0.54}Ni_{0.23}Co_{0.08}O₂.

4. The cathode of claim 1, wherein the cathode exhibits a voltage of at least 3 V versus lithium metal.

5. The cathode of claim 1, wherein, when placed in a rechargeable battery, the cathode exhibits less voltage decay after 10 cycles than a cathode in an otherwise identical battery containing a lithium-rich layered oxide with less or no cobalt in a composition.

6. A rechargeable battery comprising a cathode comprising an electrochemically active lithium-rich layered oxide having the general formula Li_{(1.33-0.67x-y)}Mn_{(0.67-0.5z-0.33x)}Ni_{(x-0.5z+2y)}M_{(z-y)}O₂,
wherein M is cobalt (Co), chromium (Cr), or any combination thereof,
wherein, with respect to the amount of Li, 1<(1.33−0.67x−y)<1.2,
wherein, with respect to the amount of Mn, 0.5<(0.67−0.5z−0.33x)<0.6,
wherein, with respect to the amount of Ni, 0.2<(x−0.5z+2y)<0.5, and
wherein, with respect to the amount of M, 0<(z−y)<0.13.

7. The battery of claim 6, wherein the lithium-rich layered oxide has the general formula Li_{1.2-x}Mn_{0.54}Ni_{0.13+2x}Co_{0.13-x}O₂, wherein 0<x<0.13.

8. The battery of claim 6, wherein the lithium-rich layered oxide has the general formula Li_{1.15}Mn_{0.54}Ni_{0.23}Co_{0.08}O₂.

9. The battery of claim 6, further comprising an anode comprising lithium metal, an unmodified carbon, a modified carbon, a titanate, or any combinations thereof.

10. The battery of claim 6, wherein the battery has a voltage of at least 2 V.

11. The battery of claim 6, wherein the cathode exhibits a voltage of at least 3 V versus lithium metal.

12. The battery of claim 6, wherein the battery further comprises and anode that exhibits a voltage of less than or equal to 2 V versus lithium metal.

13. The battery of claim 12, wherein the anode comprises lithium metal, carbon, or a titanate compound.

14. The battery of claim 6, wherein the battery exhibits less voltage decay after 10 cycles than an otherwise identical battery containing a lithium-rich layered oxide with less or no cobalt.

15. The battery of claim 6, wherein the battery comprises a computer.

16. An automotive battery comprising at least one rechargeable battery comprising a cathode comprising an electrochemically active lithium-rich layered oxide having the general formula Li_{(1.33-0.67x-y)}Mn_{(0.67-0.5z-0.33x)}Ni_{(x-0.5z+2y)}M_{(z-y)}O₂,
wherein M is cobalt (Co), chromium (Cr), or any combination thereof,
wherein, with respect to the amount of Li, 1<(1.33−0.67x−y)<1.2,
wherein, with respect to the amount of Mn, 0.5<(0.67−0.5z−0.33x)<0.6,
wherein, with respect to the amount of Ni, 0.2<(x−0.5z+2y)<0.5, and
wherein, with respect to the amount of M, 0<(z−y)<0.13.

17. The automotive battery of claim 16, wherein the lithium-rich layered oxide has the general formula Li_{1.2-x}Mn_{0.54}Ni_{0.13+2x}Co_{0.13-x}O₂, wherein 0<x<0.13.

18. The automotive battery of claim 16, wherein the lithium-rich layered oxide has the general formula Li_{1.15}Mn_{0.54}Ni_{0.23}Co_{0.08}O₂.

19. The automotive battery of claim 16, wherein the battery exhibits less voltage decay after 10 cycles than an otherwise identical battery containing a lithium-rich layered oxide with less or no cobalt.

20. The automotive battery of claim 16, wherein the battery comprises a computer.
